(19) United States
(12) Patent Application Publication
(10) Pub. No.: US 2003/0088766 A1
(43) Pub. Date: May 8, 2003

(54) Secure communication protocol utilizing a private key delivered via a secure protocol

(76) Inventor: Glenn R. Engel, Snohomish, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/005,749

(22) Filed: Nov. 7, 2001

(51) Int. Cl. H04L 9/00

(52) U.S. Cl. 713/150

(57) ABSTRACT

A method for operating a computer system having first, second, and third data processors connected by a network. The second and third data processors are connected by an insecure network segment, while the first and third data processors are connected by a network segment that has a higher level of security than the insecure network segment. A secure communication between the first and second data processors is established by having the second data processor send an encryption key for a first encryption protocol to the third data processor utilizing a second encryption protocol. The third data processor forwards the encryption key to the first data processor. The first data processor then sends a message to the second data processor utilizing the encryption key and the first encryption protocol.

### FIELD OF THE INVENTION

The present invention relates to communications between data processing elements in a network, and more particularly, to a method of delivering a key for use in a private encryption scheme while protecting the key from being compromised in transit.

### BACKGROUND OF THE INVENTION

Providing secure communications between two data processing systems is particularly important when the communication path includes segments that are on a publicly available network such as the Internet. Numerous encryption protocols have been designed to address this problem. These protocols can be divided into two broad categories, private key and public key systems. In public key systems, both the algorithm used to encrypt the data and the public key can be given to an eavesdropper compromising the encrypted communication. Hence, when a first data processing system wishes to receive data in a secure communication from a second data processing system, it need only send its public key and encryption method to the second data processing system. The second data processing system can then encrypt messages to the first data processing system. For a sufficiently large public key, the encrypted messages cannot be decrypted in a reasonable amount of time by any third party having only knowledge of the public key and encryption algorithm.

Unfortunately, public key encryption systems are computationally intense, and hence, both of the data processing systems must have sufficient computational power to execute the underlying algorithms. In a number of situations, at least one of the data processing systems has only limited computational power. Consider a data processing system in which a data collection node collects data from a number of sensors and reports that data to a server that is connected to the data collection node by a network having a segment that includes the Internet or some other non-secure network. The data collection node often consists of a small controller and appropriate interface circuits such as analog to digital converters. The controller has only sufficient computational capacity to collect data and send that data over the network. This limited capacity reflects cost constraints on the data collection node. Hence, increasing the computational power of the data collection node to enable the controller to execute one of the public key algorithms is not always an option.

In principle, the communication between the data collection node and the server that accumulates the data can be encrypted utilizing a private key encryption system. Private key encryption algorithms that are much less computationally complex than the public key encryption algorithms are known to the art. For example, a message can be encrypted by rearranging or replacing the bits of the message by their complements in a manner determined by a private key. If the private key is sufficiently large, the resulting message cannot be decrypted in a reasonable amount of time, and hence, the encrypted message is secure.

Unfortunately, private key systems require some method of delivering the private key to the second computer in a secure manner. In principle, the key can be given to the second computer at the time the second computer is installed; however, such schemes are vulnerable to attack by someone having access to the second computer. Accordingly, a scheme in which the private key changes at the beginning of each communication session is preferred. Hence, some method for delivering the key, which does not require that a high computational capacity exist in the second computer, is needed.

Broadly, it is the object of the present invention to provide an improved secure communication system for use in situations in which one computer has only limited computational capacity.

These and other objects of the present invention will become apparent to those skilled in the art from the following detailed description of the invention and the accompanying drawings.

### SUMMARY OF THE INVENTION

The present invention is a method for operating a computer system having first, second, and third data processors connected by a network. An insecure network segment connects the second and third data processors, while a network segment that has a higher level of security than the insecure network segment connects the first and third data processors. In the method of the present invention, the second data processor sends an encryption key for a first encryption protocol to the third data processor utilizing a second encryption protocol. The third data processor forwards the encryption key to the first data processor. The first data processor then sends a message to the second data processor utilizing the encryption key and the first encryption protocol, the message being sent over a communication path comprising the insecure network segment. In the present invention, the first encryption protocol requires less computational resources than the second encryption protocol. For example, the second encryption protocol can be a public key encryption protocol, while the first encryption protocol can be a private key protocol.

### BRIEF DESCRIPTION OF THE DRAWINGS

FIG. 1 is a schematic drawing of an exemplary computer system that executes the method of the present invention.

### DETAILED DESCRIPTION OF THE INVENTION

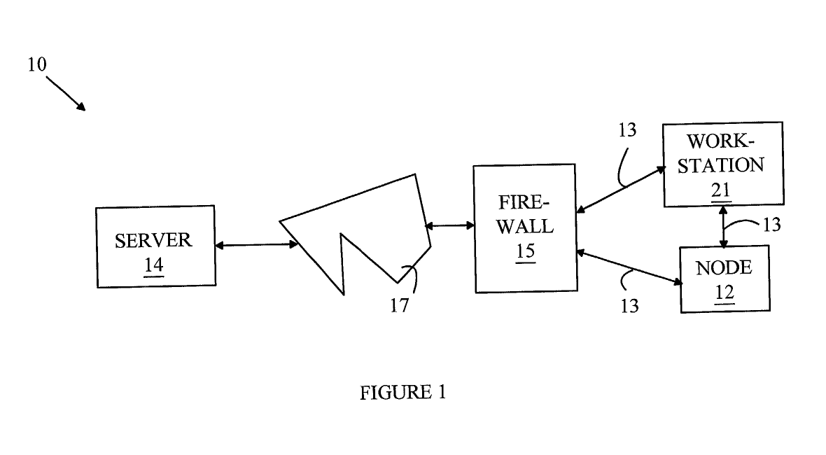

To simplify the following discussion, the present invention will be explained in terms of a computer system in which a data collection node 12 communicates with a server 14 over a network that includes the Internet. Refer now to FIG. 1, which is a schematic drawing of an exemplary computer system 10 according to the present invention. The data collection node 12 is assumed to have only limited computational capacity. The data collection node is assumed to be connected to a local area network 13 that is protected from eavesdropping by individuals that could eavesdrop on Internet communications by a firewall 15 or similar device. Data collection node 12 must communicate with server 14 over the Internet 17.

The present invention is based on the observation that local area network 13 has a much lower risk of eavesdropping than the portion of the communication path that operates over the Internet. In addition, local area network 13 usually has additional computers that have substantially more computational power than data collection node 12. Such a computer is shown at 21. In the present invention, workstation 21 obtains a private key for use by data collection node 12 in communicating with server 14 and sends that private key to data collection node 12 via local network 13.

The communications between server 14 and workstation 21 are carried out using a public key encryption protocol such as HTTPS. Workstation 21 is assumed to have sufficient computational capacity to execute such encryption schemes. When server 14 wishes to send a key to data collection node 12, server 14 addresses a secure message to workstation 21, which includes the key and the identity of data collection node 12. Workstation 21 then sends the key to data collection node 12 using a less secure protocol.

Since it is assumed that local area network 13 is restricted to authorized personnel, little or no security is needed for this communication. Once data collection node 12 has the private key, data collection node 12 uses that key to encrypt messages to be sent to server 14. These messages are preferably sent via HTTP.

To initiate communication, Workstation 21 locates data collection nodes such as data collection node 12 on it's local network and sends a request to Server 14 via a secure public key encryption protocol requesting a private key for collection node 12. After receiving the key from Server 14, Workstation 21 can send a non-secure message to collection node 12 on the local network with the key and any necessary communication settings to allow data collection node 12 to initiate communications directly with Server 14 utilizing the private key.

It should be noted that there are advantages inherent in data collection node 12 initiating the communication. Firewall 15 normally blocks messages from the internet from reaching local area network 13. However, a computer on the local area network can upload data to server 14 by using a proxy server in a manner analogous to that used to upload data from a filled-in form to a server. Such protocols allow the server to send back a response message. Hence, no alterations to the firewall are needed to provide communication between data collection node 12 and server 14.

While the present invention has been explained in terms of a particular type of network, the present invention may be utilized in a wide variety of environments in which a first computer having limited computational resources must communicate in a secure manner with a second computer. The computer having the limited computational power needs to be connected to a third computer having the necessary computational capacity to execute a secure exchange of a private key with the second computer. In addition, there must be a link between the first and third computers that is sufficiently secure to allow the forwarding of the private key from the third computer to the first computer.

Various modifications to the present invention will become apparent to those skilled in the art from the foregoing description and accompanying drawings. Accordingly, the present invention is to be limited solely by the scope of the following claims.

What is claimed is:

1. A method for operating a computer system having first, second, and third data processors connected by a network wherein said second and third data processors are connected by an insecure network segment, said method comprising the steps of:
causing said second data processor to send an encryption key for a first encryption protocol to said third data processor utilizing a second encryption protocol;
causing said third data processor to forward said encryption key to said first data processor; and
causing said first data processor to send a message to said second data processor utilizing said encryption key and said first encryption protocol, said message being sent over a communication path comprising said insecure network segment.

2. The method of claim 1 wherein said first data processor has insufficient computational resources to execute said second encryption protocol.

3. The method of claim 1 wherein said second encryption protocol is a public key encryption protocol.

4. The method of claim 1 wherein said step of causing said second data processor to send an encryption key is initiated in response to a message from said first data processor to said second data processor.

5. The method of claim 1 wherein said insecure network segment comprises the Internet.

6. The method of claim 1 wherein said network segment connecting said first and third data processors comprises a local area network.

7. The method of claim 1 wherein said first and third data processors are connected by a network segment that has a higher level of security than said insecure network segment.

8. The method of claim 1 wherein said first encryption protocol requires less computational resources than said second encryption protocol
